(19) United States
(12) Patent Application Publication
(10) Pub. No.: US 2012/0006252 A1
(43) Pub. Date: Jan. 12, 2012

(54) Indicator

(75) Inventors: Kam Eileen Warner, Perrysburg, OH (US); Christopher Hawker, Columbus, OH (US); Jessica Moreland, Columbus, OH (US)

(73) Assignee: Kam Eileen Warner, Perrysburg, OH (US)

(21) Appl. No.: 12/984,424

(22) Filed: Jan. 4, 2011

Related U.S. Application Data
(60) Provisional application No. 61/292,001, filed on Jan. 4, 2010.

(51) Int. Cl. G01D 13/02

(52) U.S. Cl. 116/284

(57) ABSTRACT

Within the several embodiments of the present disclosure, an indicator includes a body having an anterior face and a posterior face, wherein the posterior face is configured to be coupled to a vessel; a dial rotatably coupled to the body, the dial having a plurality of indicia disposed thereupon.

### CLAIM OF PRIORITY AND FAMILY STATUS

This application claims the prior filing date of provisional application No. 61/292,001, filed on Jan. 4, 2010 the entirety of which is incorporated by reference herein.

### BACKGROUND AND TECHNICAL FIELD

The present disclosure pertains at least to receptacles and packages, which in some instances could be understood to include (a) containers configured to hold a particular article or set of articles or material, (b) mercantile units—i.e., means in or by which goods (article or material) are displayed, protected, packaged or arranged in a particular manner, to facilitate sale, transportation in commerce, use or storage or (c) a packet, compact or case carried on the person of a user.

More particularly, the present disclosure pertains at least to containers having indicia, which in some instances could be understood to include (1) means intended to change in appearance or in any other sensory-evident way for the purpose of conveying information about the container or its contents, or (2) means intended to show a change in the container or its contents.

### SUMMARY

Within the several embodiments of the present disclosure, an indicator includes a body having an anterior face and a posterior face, wherein the posterior face is configured to be coupled to a vessel; a dial rotatably coupled to the body, the dial having a plurality of indicia disposed thereupon.

According to further embodiments of the present disclosure, an indicator is disclosed wherein the means for coupling the indicator to the vessel comprises a band frictionally retained about the circumference of the vessel and coupled to the posterior face of the body.

According to further embodiments of the present disclosure, an indicator is disclosed wherein the means for coupling the indicator to the vessel is corresponding features disposed upon both the posterior face of the vessel and the body selected from the group of, hook and loop fasteners, magnets, a magnet and a ferric alloy, adhesives, epoxies, snap-fit connector or other temporary or permanent mechanical coupling method known in the art.

According to further embodiments of the present disclosure, an indicator is disclosed, wherein the dial is a member having a substantially round footprint whose profile is selected from the group of, a substantially planar profile, a substantially concave profile, a substantially convex profile, a compound curvature profile.

According to further embodiments of the present disclosure, an indicator is disclosed, wherein the dial has an aperture extending at least partially through the center thereof, and the anterior face of the body has a complementary protrusion extending in orthogonal relation thereto operatively configured to rotably couple the dial to the body.

According to further embodiments of the present disclosure, an indicator is disclosed, wherein the dial has a protrusion extending posteriorly from the center thereof, and the anterior face of the body has a complementary aperture extending at least partially therethrough operatively configured to rotably couple the dial to the body.

According to further embodiments of the present disclosure, an indicator is disclosed, wherein the surface about the circumference of the dial is deformed by a repeating pattern and thereby operatively configured for manual translation about the rotational path of the dial.

According to further embodiments of the present disclosure, an indicator is disclosed, wherein there is a deformable member disposed upon the anterior face of the body operatively configured to temporarily mechanically interfere with the rotation of the dial.

According to further embodiments of the present disclosure, an indicator is disclosed, wherein a portion of the periphery of the dial protrudes from the circumference of the body.

According to further embodiments of the present disclosure, an indicator is disclosed, wherein there is a faceplate disposed upon the anterior portion of the indicator having an aperture disposed thereupon for viewing of the indicia therethrough.

According to further embodiments of the present disclosure, an indicator is disclosed, wherein the faceplace and body have complementary grooves and recesses disposed on the peripheries thereof operatively configured for engaging one against the other.

According to further embodiments of the present disclosure, an indicator is disclosed, wherein there are a plurality of dials rotably coupled to the body.

According to further embodiments of the present disclosure, an indicator is disclosed, wherein a plurality of dials are configured such that when their indicia are viewed together they define a single indicia, including for instance separate letters to spell a larger word or separate digits to define a larger number.

According to further embodiments of the present disclosure, an indicator is disclosed, wherein the components of the indicator are composed of a synthetic resin, a natural resin, a metal, or other suitable material known in the art.

According to further embodiments of the present disclosure, an indicator is disclosed, wherein the indicia disposed upon the dial are selected from the group of letters, numbers, symbols, days, months, times, years, or shapes.

### BRIEF DESCRIPTION OF THE FIGURES

In the figures, which are not necessarily drawn to scale, like numerals describe substantially similar components throughout the several views. The drawings illustrate generally, by way of example, but not by way of limitation, various embodiments discussed in the claims of the present document.

FIG. 1 is an isometric view of an embodiment of a detachable indicator.

FIG. 2 is an exploded isometric view of the embodiment of FIG. 1.

FIG. 3 is a front view of the embodiment of FIG. 1 having an optional anterior plate and band removed.

FIG. 4 is an isometric view of an embodiment of a detachable indicator coupled to a bottle.

FIG. 5a is a side view of the detachable indicator/bottle assembly of FIG. 4.

FIG. 5b is a front view of the detachable indicator/bottle assembly of FIG. 4.

FIG. 6a is a front view of the detachable indicator of FIG. 1.

FIG. 6b is a back view of the detachable indicator of FIG. 1.

FIG. 7a is a top view of the detachable indicator of FIG. 1.

FIG. 7b is a bottom view of the detachable indicator of FIG. 1.

FIG. 8a is a right view of the detachable indicator of FIG. 1.

FIG. 8b is a left view of the detachable indicator of FIG. 1.

### DETAILED DESCRIPTION OF THE FIGURES

With reference to FIG. 1, an embodiment of a detachable indicator 1 is shown having a body 100, a band 200, and indicators 300(a, b, and c) disposed within and rotatably coupled to body 100.

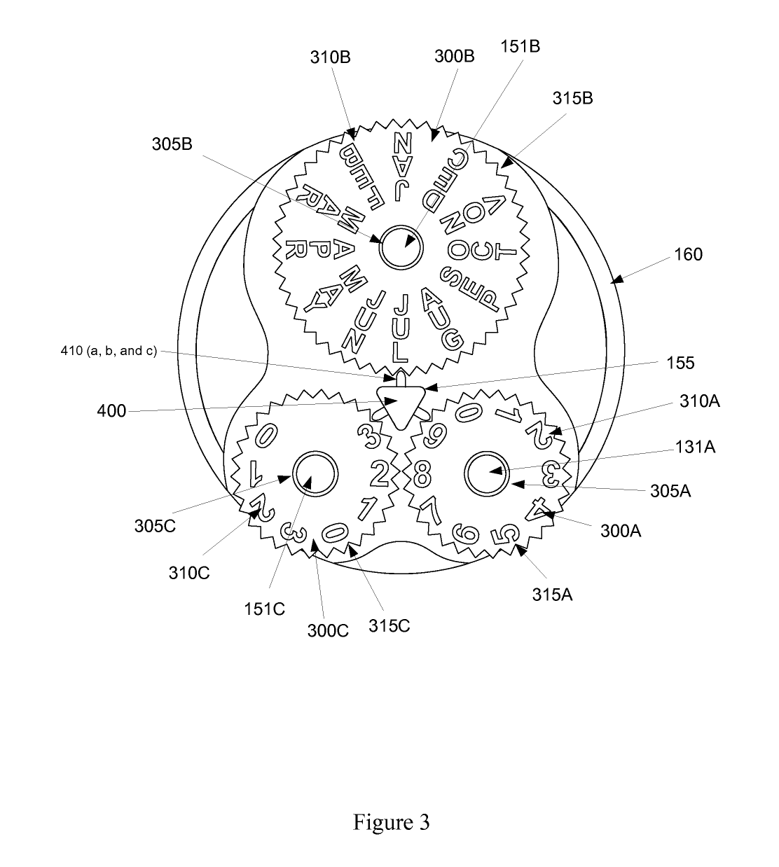

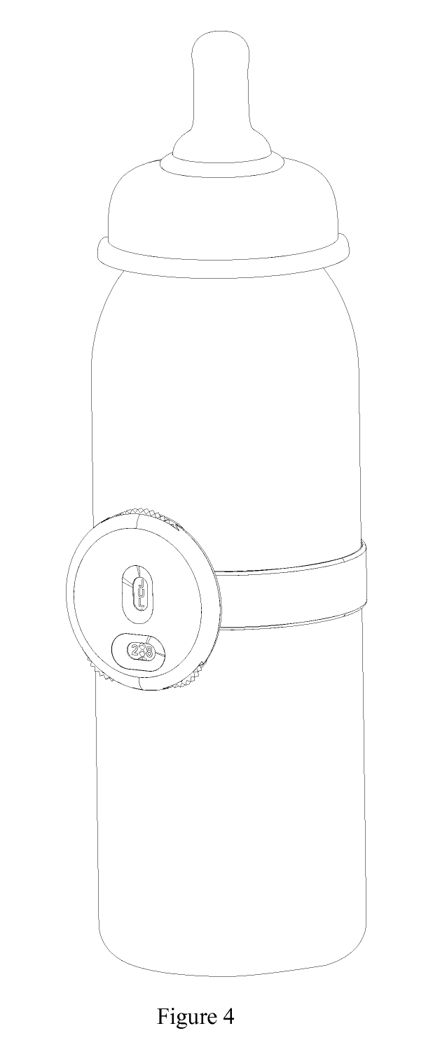

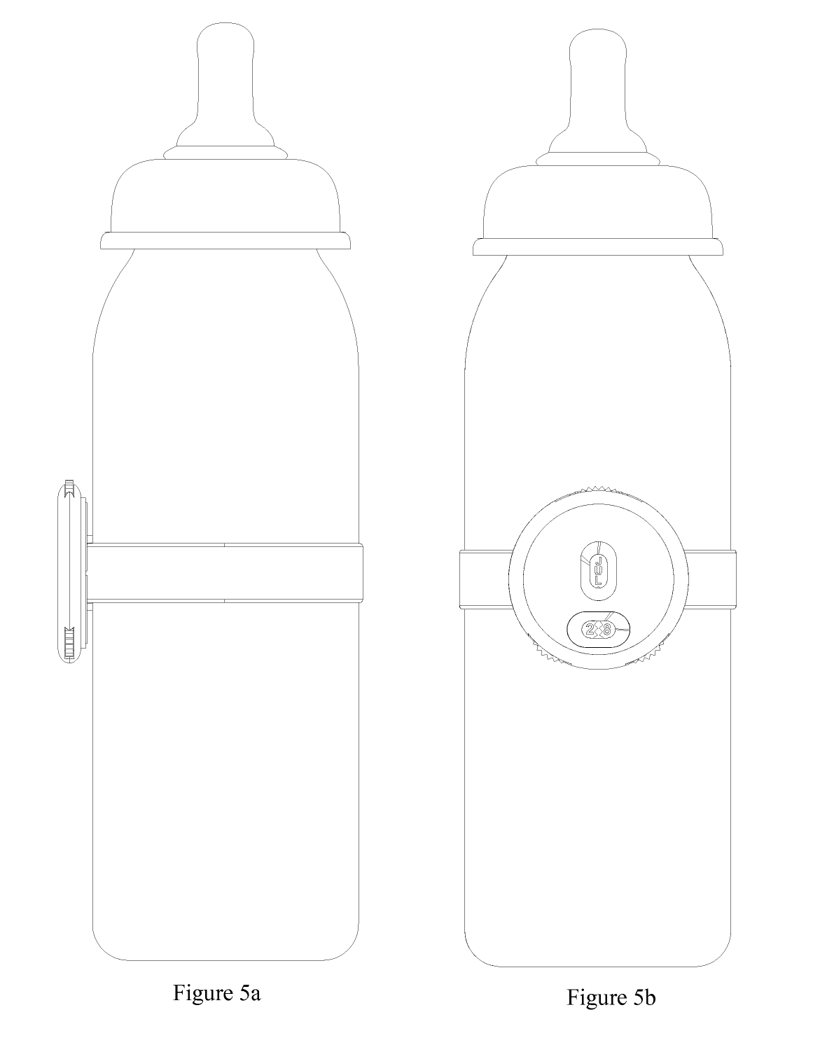

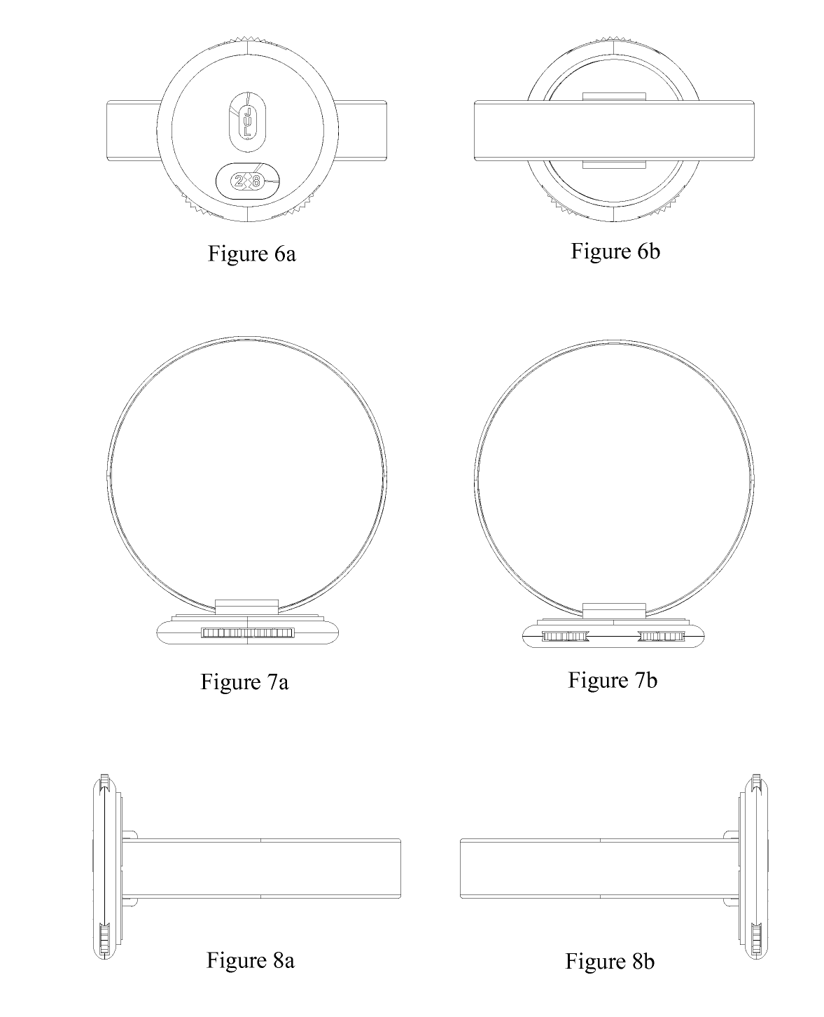

With reference to FIG. 3, there are three substantially planar, circular indicators 300(a, b, and c) disposed within body 100. The indicators 300(a, b, and c) each have a central aperture 305(a, b, and c) extending therethrough and a circumferential toothed portion 315(a, b, and c) disposed on the periphery thereof. Further, the indicators have a plurality of indicia 310(a, b and c) disposed radially thereupon. The indicia 310(a, b, and c) may comprise letters, numbers, symbols, or any combination thereof.

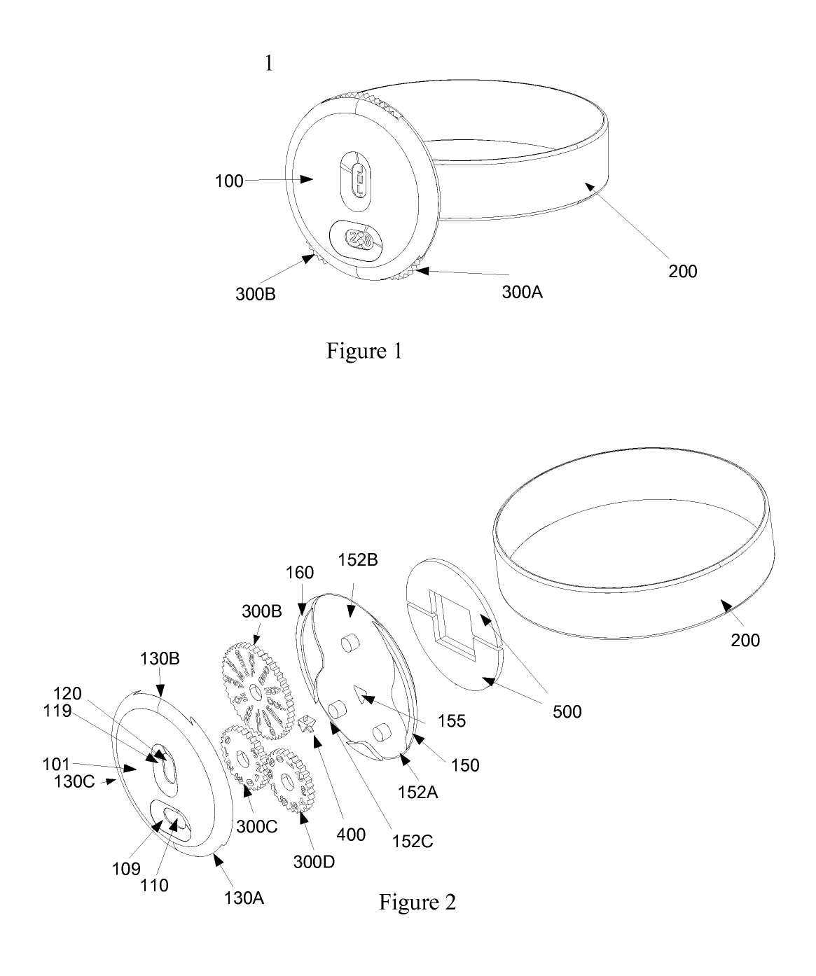

With reference to FIG. 2, body 100 further comprises a posterior plate 150. Posterior plate 150 is a substantially round and substantially planar member. Posterior plate 150 has pins 151(a, b, and c) extruded from the surface thereof and configured to receive central apertures 305(a, b, and c) of circular indicators 300(a, b, and c) respectively therewithin and facilitate rotational motion of each indicator thereabout. There is a substantially arcuate rebate 160 disposed about the circumference of posterior plate 150. Rebate 160 has openings 152(a, b, and c) removed therefrom through which segments of circumferential toothed portions 315(a, b, and c) protrude upon assembly of detachable indicator 1 as shown in FIG. 1.

With reference to FIG. 3, there is a detent-stop 400 disposed within or operatively coupled to posterior plate 150 at coupling area 155. Detent-stop 400 has complaint arms 410(a, b, and c) which abut and retain circumferential toothed portions 315(a, b, and c) of indicators 300(a, b, and c) respectively. Upon the application of tangential force upon any circumferential toothed portions 315(a, b, or c), a corresponding compliant arm 410(a, b, or c) provides a biasing force theragainst which must be overcome in order to affect a rotational displacement of an indicator 300(a, b, or c) about its respective pin 151(a, b, or c).

With reference to FIG. 2, body 100 further comprises an anterior plate 101. Anterior plate 101 has beveled recesses 109 and 119 with apertures 110 and 120 respectively disposed therewithin. Apertures 110 and 120 are configured for viewing indicia 310(a, b, and c) disposed upon indicators 300(a, b, and c) therethrough. For instance, in the embodiment shown in FIGS. 1 and 2, aperture 120 is elongated along a vertical axis for viewing an indicia 310b disposed upon a single indicator 300b. By non-limiting example, as shown in FIGS. 1, 2, and 3, this indicia may be a marking representing the month in which the contents of an attached container were prepared. By contrast, an aperture may also be configured for viewing indicia disposed upon multiple indicators. For instance, in the embodiment shown in FIGS. 1, 2 and 3, aperture 110 is elongated along a horizontal axis and configured for viewing indicia disposed upon both indicator 300b and 300c. By non-limiting example, as shown in the Figures, indicators 300b and 300c are configured to display a two-digit number in aperture 110 with indicator 310b providing the first digit and 310c providing the second digit.

With continued reference to FIG. 2, anterior plate 101 has a substantially arcuate rebate 111 disposed about the periphery thereof. Rebate 111 has a plurality of openings 130(a, b, and c) removed therefrom through which circumferential toothed portions 315(a, b, and c) protrude upon assembly of detachable indicator 1 as shown in FIG. 1.

With continued reference to FIG. 2, detachable indicator 1 has a band 200 coupled to a fixing plate 500. Fixing plate 500 is in turn coupled to posterior plate 150. Band 200 may be either a rigid or complaint member configured to removably couple detachable indicator 1 to a container, including for instance a formula bottle as shown in FIG. 4.

There are embodiments within the scope of the present disclosure, wherein the positions of the indicators 300 (a, b, or c) may be fixed in place by mechanical interference from a screw, lever, pad, stop, or other mechanism known in the art.

Although in the embodiment shown in FIG. 1 there are three indicators, 300a, 300b, and 300c, there are embodiments within the scope of the present disclosure wherein there are as few as one indicator, or additional indicators rotatably coupled to body 100.

Although in the embodiment shown in FIG. 1 indicators 300a, 300b, and 300c are substantially enclosed within body 100, there are embodiments within the scope of the present disclosure wherein one or more indicators are rotatably coupled to a body without being substantially enclosed therewithin, including for instance as shown in FIG. 3.

Although in the embodiment shown in FIG. 1 indicators 300(a, b, and c) are held in place by extruded pins 151(a, b, and c), there are embodiments within the scope of the present disclosure wherein one or more indicators are rotatably coupled to a body by a separate pin, stepped shoulder, screw, bolt, or other coupling devices known in the art.

Although in the embodiment shown in FIG. 1 indicators 300(a, b, and c) are held in place by pins 151(a, b, and c), there are embodiments within the scope of the present disclosure wherein one or more indicators are rotatably coupled to a body by a ridge disposed about the periphery of that body.

Although in the embodiment shown in FIG. 1 body 100 and indicators 300(a, b, c) are substantially planar, there are embodiments within the scope of the present disclosure wherein either body 100, indicators 300(a, b, and c), or both have substantial shape or depth. In one non-limiting example, it is contemplated that indicators 300a, 300b, and 300c may comprise all or a portion of a hemisphere. In another non-limiting example, it is further contemplated that body 100 may comprise all or a portion of hemisphere.

Although in the embodiment shown in the figures, indicators 300(a, b, and c) are manipulated into consecutive states by a user applying tangential force upon toothed circumferential portion 315(a, b, or c), there are embodiments of the present disclosure wherein indicators 300(a, b, and c) may be displaced by a user through manipulation of a knob or lever disposed on body 100 through either direct or geared coupling to the appropriate indicator.

Although in the embodiment shown in the figures, a detachable indicator is coupled to a container by a band, there are embodiments within the scope of the present disclosure wherein an indicator may be coupled to a container using other coupling devices known in the art, including, but not limited to a magnet, a clip, a clamp, a suction cup, a protrusion on the indicator, or a protrusion on the container.

Although in the embodiment shown in the figures, an indicator is detachable, there are embodiments within the scope of the present disclosure wherein an indicator may be permanently coupled to a container.

Although in the embodiment shown in the figures, detent stops along the rotational paths of indicators 300(a, b, and c) are provided by a single member, there are embodiments within the scope of the present disclosure where a detent may be provided by a complaint flange, or any other compliant member known in the art which is capable of deformably interfering with the rotation of an indicator 300(a, b, or c).

Although in the embodiment shown in the figures, indicators 300(a, b, and c) are capable of turning both clockwise and counter-clockwise, there are embodiments within the scope of the present disclosure wherein a mechanism is provided to only allow rotation of the indicators in a single direction, including for instance stepped ratcheting mechanisms or other mechanisms known in the art.

A method of using the embodiment of a detachable indicator shown in FIGS. 1 and 2 will now be described with reference to FIG. 4. First, a user receives detachable indicator 1 in a first state in which a first group of indicia is displayed through the aperture(s) on the anterior plate. In order to operate the detachable indicator 1, an operator applies sufficient tangential force to toothed circumferential portion 315(a, b, or c) with a digit to deform compliant arms 410 and overcome the bias provided by arms 410(a, b, or c) against the circumferential toothed portion 315(a, b, or c) to rotate indicator 300(a, b, or c) about pin 151(a, b, or c) such that indicator 300(a, b, or c) comes into a second state wherein a second indicia is displayed through an aperture and the anterior plate. This process is repeated until the desired combination of indicia is displayed in the appropriate apertures.

Compliant arms 410, may be optionally configured to provide a tactile and/or acoustic notification to a user upon successful displacement of an indicator 300(a, b, or c).

Either before or after a user has configured a detachable indicator into their desired state, he/she may couple the indicator to a container, including, but not limited to a food storage container.

In the preceding description, unless described as being complaint or flexible, components of the assembly may be constructed of any formable rigid materials known in the art, including but not limited to natural and synthetic polymers, resins, or metals.

In the preceding description, any rigid coupling of two members to one another may occur through the use appropriate coupling methods known in the art, including, but not limited to press-fitting, snap fitting, clips, adhesives, welding, chemical welding, sonic welding, screws, or devises.

With reference to the embodiments shown in the Figures a detachable indicator 1 is configured for record and display the date on which infant formula was prepared or breast milk drawn. Indicator 1 may be further coupled to a vessel containing said formula or milk including, for instance, an infant's bottle. The present disclosure however, is not limited to such an implementation.

Consequently, any vessel or container may be used in place of an infants bottle within the scope of the present disclosure including, but not limited to (a) containers configured to hold a particular article or set of articles or material; (b) mercantile units—i.e., means in or by which goods (article or material) are displayed, protected, packaged or arranged in a particular manner, to facilitate sale, transportation in commerce, use or storage or (c) a packet, compact or case carried on the person of a user.

Further, the indicia displayed by the indicator may be any information pertinent to the contents of the container or vessel, including, but not limited to age, contents, completeness of a processing task, quantity contained with vessel, or quality of goods contained within the vessel.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An indicator comprises:
a body having an anterior face and a posterior face,
wherein the posterior face is configured to be coupled to a vessel;
a dial rotatably coupled to the body, the dial having a plurality of indicia disposed thereupon.

2. The indicator of claim 1, wherein the means for coupling the indicator to the vessel comprises a band frictionally retained about the circumference of the vessel and coupled to the posterior face of the body.

3. The indicator of claim 1, wherein the means for coupling the indicator to the vessel is corresponding features disposed upon both the posterior face of the vessel and the body selected from the group of, hook and loop fasteners, magnets, a magnet and a ferric alloy, adhesives, epoxies, snap-fit connector or other temporary or permanent mechanical coupling method known in the art.

4. The indicator of claim 1, wherein the dial is a member having a substantially round footprint whose profile is selected from the group of, a substantially planar profile, a substantially concave profile, a substantially convex profile, a compound curvature profile.

5. The indicator of claim 1, wherein the dial has an aperture extending at least partially through the center thereof, and the anterior face of the body has a complementary protrusion extending in orthogonal relation thereto operatively configured to rotably couple the dial to the body.

6. The indicator of claim 1, wherein the dial has a protrusion extending posteriorly from the center thereof, and the anterior face of the body has a complementary aperture extending at least partially therethrough operatively configured to rotably couple the dial to the body.

7. The indicator of claim 1, wherein the surface about the circumference of the dial is deformed by a repeating pattern and thereby operatively configured for manual translation about the rotational path of the dial.

8. The indicator of claim 7, wherein there is a deformable member disposed upon the anterior face of the body operatively configured to temporarily mechanically interfere with the rotation of the dial.

9. The indicator of claim 8, wherein a portion of the periphery of the dial protrudes from the circumference of the body.

10. The indicator of claim 1, wherein there is a faceplate disposed upon the anterior portion of the indicator having an aperture disposed thereupon for viewing of the indicia therethrough.

11. The indicator of claim 10, wherein the faceplace and body have complementary grooves and recesses disposed on the peripheries thereof operatively configured for engaging one against the other.

12. The indicator of claim 1, wherein there are a plurality of dials rotably coupled to the body.

13. The indicator of claim 12, wherein a plurality of dials are configured such that when their indicia are viewed together they define a single indicia, including for instance separate letters to spell a larger word or separate digits to define a larger number.

14. The indicator of claim 1, wherein the components of the indicator are composed of a synthetic resin, a natural resin, a metal, or other suitable material known in the art.

15. The indicator of claim 1, wherein the indicia disposed upon the dial are selected from the group of letters, numbers, symbols, days, months, times, years, or shapes.
